(19) United States
(12) Patent Application Publication
(10) Pub. No.: US 2008/0282870 A1
(43) Pub. Date: Nov. 20, 2008

(54) Automated disc jockey

(75) Inventors: Raymond Carrick, Edinburgh (GB); George Anthony Bett, Edinburgh (GB)

Correspondence Address: HARRINGTON & SMITH, PC, 4 RESEARCH DRIVE, SHELTON, CT, 06484-6212, US

(73) Assignee: The University Court of the University of Edinburgh

(21) Appl. No.: 12/150,967

(22) Filed: May 2, 2008

(30) Foreign Application Priority Data
May 12, 2007 (GB) 0709174.7

(51) Int. Cl. G10H 1/00

(52) U.S. Cl. 84/601

(57) ABSTRACT

An automated disc jockey. It accesses a database that models multiple music tracks as linked data objects. Each music track model includes a music track data object identifying the music track and linked to a plurality of other data objects that parameterize metadata of the music track. Some of the other data objects are sharable data objects that may be linked from other music track data objects. Data objects and links defining a model of a first music track are extracted from the accessed database. Data objects and links that define a model of a second music track that is adjacent to and follows the first music track in a play-list are extracted from the accessed database. A sub-set of the extracted data objects and links, including interconnecting data objects and links that interconnect a first music track data object for the first music track and a second music track data object for the second music track via a shared data object that is shared between the model for the first music track and the model for the second music track, is selected. The interconnecting data objects and links are processed to manufacture disc jockey commentary that joins the first music track and the second music track.

### FIELD OF THE INVENTION

Embodiments of the present invention relate to an automated disc jockey.

### BACKGROUND TO THE INVENTION

Automation of industrial processes has continued through the 20th and 21st centuries. For example, robots are now extensively used in the manufacture of motor vehicles. The use of robots increases efficiency and consistency.

It would be desirable to automate other industries to achieve similar advantages.

### BRIEF DESCRIPTION OF VARIOUS EMBODIMENTS OF THE INVENTION

According to some embodiments of the invention there is provided an automated disc jockey comprising: means for accessing a database that models multiple music tracks as linked data objects each music track model comprising a music track data object, at least identifying the music track, linked to a plurality of other data objects that parameterize metadata of the music track, wherein at least some of the other data objects are sharable data objects that may be linked from any music track data object; means for extracting, from the accessed database, data objects and links defining a model of a first music track; means for extracting, from the accessed database, data objects and links that define a model of a second music track that is adjacent to and follows the first music track in a play-list; means for selecting a sub-set of the extracted data objects and links including interconnecting data objects and links that interconnect a first music track data object for the first music track and a second music track data object for the second music track via a shared data object that is shared between the model for the first music track and the model for the second music track; and means for processing the interconnecting data objects and links to manufacture disc jockey commentary that joins the first music track and the second music track.

According to some embodiments of the invention there is provided a computer-based method for manufacturing disc jockey commentary joining music tracks comprising: accessing a database that models multiple music tracks as linked data objects each music track model comprising a music track data object, identifying the music track, linked to a plurality of other data objects that parameterize metadata of the music track, wherein at least some of the other data objects are sharable data objects that may be linked from any music track data object; extracting, from the accessed database, data objects and links defining a model a first music track; extracting, from the accessed database, data objects and links that define a model a second music track that is adjacent to and follows the first music track in a play-list; selecting a sub-set of the extracted data objects and links including interconnecting data objects and links that interconnect a first music track data object for the first music track and a second music track data object for the second music track via a shared data object that is shared between the model for the first music track and the model for the second music track; and computer processing the interconnecting data objects and links to manufacture a disc jockey commentary that joins the first music track and the second music track.

According to some embodiments of the invention there is provided an automated method of simulating a radio station comprising: accessing a database that models multiple music tracks as linked data objects each music track model comprising a music track data object, identifying the music track, linked to a plurality of other data objects that parameterize metadata of the music track, wherein at least some of the other data objects are sharable data objects that may be linked from any music track data object; extracting, from the accessed database, data objects and links defining a model a first music track; extracting, from the accessed database, data objects and links that define a model a second music track that is adjacent to and follows the first music track in a play-list; selecting a sub-set of the extracted data objects and links including interconnecting data objects and links that interconnect a first music track data object for the first music track and a second music track data object for the second music track via a shared data object that is shared between the model for the first music track and the model for the second music track; computer processing the interconnecting data objects and links to manufacture a disc jockey commentary that joins the first music track and the second music track; playing the first music track; playing the disc jockey commentary; and then playing the second music track.

According to some embodiments of the invention there is provided a computerized disc jockey comprising: means for accessing a database that models multiple music tracks as linked data objects each music track model comprising a music track data object, identifying the music track, linked to a plurality of other data objects that parameterize metadata of the music track, wherein at least some of the other data objects are sharable data objects that may be linked from any music track data object; means for extracting, from the accessed database, data objects and links defining a model a first music track; means for extracting, from the accessed database, data objects and links that define a model a second music track that is adjacent to and follows the first music track in a play-list; means for selecting a sub-set of the extracted data objects; and means for processing the sub-set of data objects and links to manufacture disc jockey commentary that joins the first music track and the second music track.

According to some embodiments of the invention there is provided a computer-based method for manufacturing disc jockey commentary joining music tracks comprising: accessing a database that models multiple music tracks as linked data objects each music track model comprising a music track data object, identifying the music track, linked to a plurality of other data objects that parameterize metadata of the music track, wherein at least some of the other data objects are sharable data objects that may be linked from any music track data object; extracting, from the accessed database, data objects and links defining a model a first music track; extracting, from the accessed database, data objects and links that define a model a second music track that is adjacent to and follows the first music track in a play-list; selecting a sub-set of the extracted data objects and links; and computer processing the sub-set of data objects and links to manufacture and record a disc jockey commentary that joins the first music track and the second music track.

According to some embodiments of the invention there is provided a computerized disc jockey comprising: hardware configured to access a database that models multiple music tracks as linked data objects each music track model comprising a music track data object, at least identifying the music track, linked to a plurality of other data objects that parameterize metadata of the music track, wherein at least some of the other data objects are sharable data objects that may be linked from any music track data object; hardware configured to extract, from the accessed database, data objects and links defining a model of a first music track; hardware configured to extract, from the accessed database, data objects and links that define a model of a second music track that is adjacent to and follows the first music track in a play-list; and hardware configured to modify the processing of data objects used in manufacturing disc jockey commentary in response to determined user data by selecting a sub-set of the extracted data objects and links, dependent upon the determined user data, including interconnecting data objects and links that interconnect a first music track data object for the first music track and a second music track data object for the second music track via a shared data object that is shared between the model for the first music track and the model for the second music track, and configured to process the selected interconnecting data objects and links to manufacture disc jockey commentary that joins the first music track and the second music track.

Various embodiments of the invention provide systems, apparatus and methods that automate an industrial process i.e. the manufacture and provision of media, in this case a disc jockey commentary, to a user.

Automation of the industrial process increases efficiency and consistency. It results in the industrial process being de-coupled from a few specialist locations and enables manufacturing at multiple sites and bespoke manufacturing.

The manufactured product is useful, concrete and tangible. Automated manufacturing of the product provides a technical contribution as does automated modification of the manufacturing process in response to determined user data.

### BRIEF DESCRIPTION OF THE DRAWINGS

For a better understanding of various embodiments of the present invention reference will now be made by way of example only to the accompanying drawings in which:

FIG. 1 schematically illustrates an automated disc jockey system;

FIGS. 2A and 2B schematically illustrate simplified entity relationship networks modeling music tracks; and

FIG. 3 schematically illustrates a method of manufacturing a disc jockey commentary.

### DETAILED DESCRIPTION OF VARIOUS EMBODIMENTS OF THE INVENTION

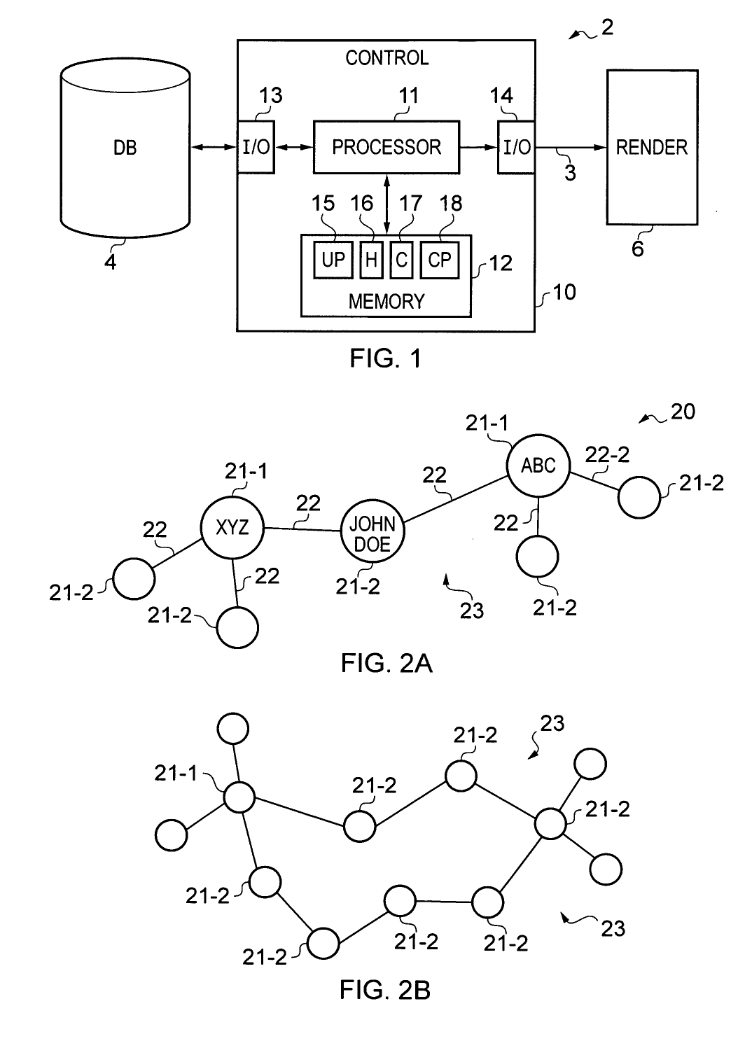

FIG. 1 schematically illustrates an automated disc jockey system 2 for manufacturing disc jockey commentary 3. The automated disc jockey comprises: a database component 4 comprising one or more databases; a rendering component 6; and a control component 10 for accessing the database component and for manufacturing a disc jockey commentary 3 that is rendered by the rendering component 6.

The system 2 may be one apparatus or the system 2 may be distributed across multiple different apparatuses.

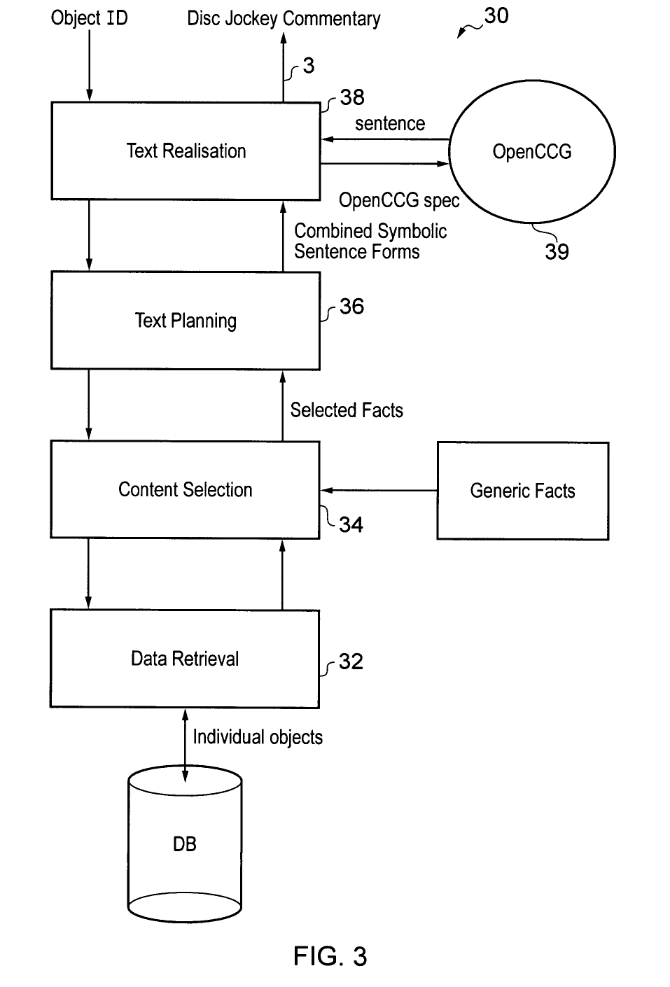

The control component 10 performs the following functions, as illustrated in FIG. 3: data retrieval 32 from the database component 4; content selection 34 from the retrieved data; symbolic text planning 36 and natural language realization 38.

These functions will be described in more detail with reference to FIG. 3 below.

The control component 10 is a non-conventional component that may be implemented entirely in hardware, or as a combination of hardware and firmware and/or software. A hardware implementation may, for example, use application specific integrated circuits.

FIG. 1 illustrates a software implementation in which the control component comprises a processor 11, a memory 12, a first input/output interface 13 connected to the database component 4 and a second interface 14 connected to the rendering component 6.

If the disc jockey system is implemented as a single apparatus, the first input/output interface 13 may, for example, be a memory controller and the second interface 14 may be, for example, an output device controller.

If the disc jockey system is implemented as a distributed system, the first input/output interface 13 may, for example, be transceiver for remote telecommunication and the second interface 14 may be, for example, the same or a different transceiver for remote telecommunication.

The processor 11 is connected to read from and write to the memory 12, to interrogate the database component and to receive replies via the first interface 13 and to control the rendering component 6 via the second interface.

In some embodiments, the rendering component may be a personal electronic device having a user input mechanism. In this situation, the second interface 14 may be an input/output interface and user commands or user data may be received at the processor 11 via the second interface. For example, the rendering component 6 may send a play-list to the control component 10.

The memory 12 represents one or more memory components or storage devices. The memory 12 stores at least one user profile as a first data structure 15, a history of past commentary in symbolic form as a second data structure 16, a disc jockey commentary 3 in natural language form before it is sent to the rendering component 6 as third data structure 17, and a computer program 18

The computer program 18 has instructions that control the operation of the control component 10 when loaded into the processor 11. The computer program instructions 18 provide the logic and routines that enables the control component 10 to perform the methods illustrated in FIG. 3.

The computer program 18 may arrive at the control component 10 via an electromagnetic carrier signal or be copied from a physical entity such as a computer program product, a memory device or a record medium such as a CD-ROM or DVD.

The database component stores data relating to a plurality of music tracks as an Entity-Relationship network.

A simplified entity relationship network 20 is illustrated in FIG. 2A and another in FIG. 2B.

The entity-relationship network 20 stores data objects (entities) 21 and links them by facts (relations) 22 which connect them.

The database component 4 models multiple music tracks as linked data objects 21. Each music track model comprises a music track data object 21-1 that identifies the music track and a plurality of other data objects 21-2 that parameterize metadata of the music track and are linked directly or indirectly to the music track data object 21-1.

For example, music track data object “track XYZ”, is linked 22 to a data object 21-2 called “John Doe” by a relationship called “lyrics by”, in turn, the data object “John Doe” 21-2 is linked 22 to a music track data object “track ABC” 21-2 by a relationship called “vocals by”. There is consequently a path 23 between the music track data object “track XYZ” and the music track data object “track ABC” 21-2.

Some of the data objects are sharable data objects that may be linked from any music track data object. For example, the data object “John Doe” is a shared data object that is linked to both the music track data object “track XYZ” and the music track data object “track ABC”.

For practical purposes entity-relationship network is flattened into a simple object database for storage.

Albums, record companies, artists, bands, band members, orchestras are examples of possible data objects that would be linked to a music track data object. The linking facts would be things like who performed the track, who wrote it, chart positions, other artists who covered it etc.

FIG. 2B illustrates a more complex entity-relationship network in which there are multiple parallel paths 23 between music track data objects that have more than one shared data object 21-2.

A music track play list identifies a plurality of music tracks which are used by the control component 10 to extract from the database component 4 the respective music track data objects and limited subsets of the entity-relationship network surrounding those music track data objects that model the respective identified music tracks. This is illustrated at block 32 of FIG. 3.

The depth (number of links from the target music track data object) of the subset retrieved is controlled by a user adjustable parameter. Typically only a small section of the complete network is extracted based on the premise that the most interesting things to say about a music track will probably be those facts represented by directly connected links/data objects or those close to it.

For example, if a play-list lists a first music track XYZ followed immediately by a second music track ABC, the control component extracts, from the database component, data objects and links defining a model of a first music track and; extracts, from the database, data objects and links that define a model of the second music track that is adjacent to and follows the first music track in the play-list.

Each extracted data object used to model a particular music track is a candidate for selection at block 34 in FIG. 3. Each candidate data object has a path 23 of N link(s) and N object(s) originating at the music track data object for the particular music track and terminating at the candidate object.

Each of the link(s) and/or object(s) in a path 23 is given an associated interest value e.g. a numeric value expressing interest level.

The control component 10 then determines, for each candidate object, a cumulative value for the interest values associated with the links/objects of the path of each candidate data object e.g. the control component may multiply or add together each of the interest values for the data objects/links along the path.

The control component 10 then selects one or more of the extracted candidate objects for inclusion in the sub-set using the respective cumulative values.

Suppose the fact that object ‘track XYZ’ has lyrics by ‘John Doe’ is not considered very interesting for user A then the interest rating of the related fact ‘track ABC’ has vocals by ‘John Doe’ is affected by this. So to calculate the interest rating of the fact “track ABC has vocals by John Doe”, one takes into account both it's inherent interest rating for this user type and also the interest ratings of all the facts that connect it to the focal object. Likewise, if you reverse this and the fact that the “track ABC has vocals by John Doe” is really important to this user according to the user profile, then the fact that “track XYZ has lyrics by John Doe” becomes more important as a result.

The interest values of links/objects may be weighted.

For example, if a link/object lies in a path between two music track data objects that are consecutive in a play-list, then the control component may increase a weighting applied to the cumulative value for that link/object. This weighting favors selection of shared objects. Other mechanism for favoring the selection of shared objects may also be used.

For example, if link/object lies in a path between two music track data objects that are consecutive in a play-list, then the weighting may be increased in dependence upon the length of the path.

The selection of the a sub-set of the candidate data objects may be considered to be a constrained optimization problem. The constraints are the order of the tracks in the predetermined play-list and the problem is, for pairs of adjacent tracks in the play-list, to maximize the cumulative value of the path interconnecting the respective music track data objects.

The optimization may alternatively be re-defined as an unconstrained optimization problem, The order of tracks in the play-list may be varied or tracks may be selected for a play-list such that, for pairs of adjacent tracks in the play-list, the cumulative value for a path interconnecting the music track data objects is maximized or such that the sum of cumulative values for music track pairs in the play-list is maximized. Thus the controller component may be used to generate a play-list.

The interest values described above may also be dependent upon a user profile 15 which may be stored in the memory 12.

The concept of a user profile is used for content selection and also for text planning. A user may therefore receive a bespoke commentary that has been manufactured according to the user profile. Thus different users may get very different commentaries for the same play-list.

In one possible implementation, a user profile is one of a set of predefined possible user profiles. A particular user profile is assigned to a user. For example, we might have three user profiles: child, adult and expert. For the child user, less information would be presented and it would be presented in a simpler way; for the adult and expert users the language would be more complex and more information would be given.

In another implementation, a user profile is at least partially user defined. For example, a user profile may be determined by a set of sliders representing the types of information in the database and by setting the sliders the user chooses what types of information are more or less interesting.

In another implementation, a user profile is dynamic and is updated on an on-going basis automatically. For example, it may be dependent upon action by the user such as which Internet sites the user visits, which music tracks the user has or buys etc. For example, a fact that relates to “track ABC” or “John Doe” may be by default of low interest but the interest value may be increased if, for example, the user has other tracks by John Doe or has track ABC or has recently accessed web-pages mentioning John Doe or track ABC.

The content selection 34 may also include generics facts 35. Generic facts are facts which are not specific and for example explain a term. They are used in dependence on the user profile and are typically used no more than once in a commentary. An example might be the fact “Jazz is a style of music, originating in early 20th Century New Orleans USA, that has a strong and flexible rhythm with improvisations on basic tunes and chords.” This fact does not relate to a single music track but to a class of music tracks. The generic fact is used only once in a commentary.

Generic facts could be things about styles of music, historical events and the like. In addition to this, the system 2 will not say make the same comment twice. If a particular fact such as “John Doe grew up in Denver” gets expressed as part of a commentary that is recorded in the history 16 in memory 12. If a John Doe features in a later commentary, repetition of the fact that John Doe grew up in Denver may be prevented.

The result of the content selection 34 is a set of facts to be expressed. The text planning stage 36 processes the selected objects and links to manufacture a ‘rough’ disc jockey commentary in symbolic form.

There may be multiple ways of expressing facts For example, one could say in relation to a track that has been played: “That track has lyrics by John Doe” or “Those lyrics were written by John Doe”.

One could say in relation to a track that will be played: “The next track has vocals by John Doe” or “The singer on the next track is John Doe” or “John Doe is the singer of the next track”.

The choice of expression used may be based upon the user profile and/or the history of the commentary.

In addition, the choice of expression used may be depend upon the entity-relationship network.

For example, objects and links that join first and second music track data objects of consecutive first and second music tracks in the play-list are processed to manufacture a commentary that joins the first and second music tracks.

The interconnecting link(s) and data objects, if any, between the first music track data object and a selected shared data object are processed to produce a first portion of the commentary e.g. “Those lyrics were written by”, The interconnecting link(s) and data objects, if any, between the second music track data object and the selected shared data object are processed to produce a second portion of the commentary e.g. “is the singer of the next track”. The selected shared data object is then processed to produce a linking portion that links the first and second portions e.g. “John Doe”.

Having chosen what facts and how to express them, the system then tries to put them together in elegant ways. This is referred to as aggregation. Aggregation takes a set of single facts and combines them into complex sentence structures

For example, “Those lyrics were written by John Doe. John Joe is the singer of the next track” may be converted to “Those lyrics were written by John Doe who is also the singer of the next track”.

The next block is text realization 38. Up to this point all of the text specifications have been in a symbolic language independent form which would be generally incomprehensible to a human. Text Realization takes that symbolic form and creates natural language from it.

The result of the text planning stage is a set of symbolic sentence specifications. The text Realization takes each of these and passes them to a grammar system 39 such as OpenCCG. OpenCCG is a open source grammar system which takes the symbolic sentence specification and returns a real English sentence. The text realization takes these returned sentences and combines them to return the final natural language disc jockey commentary 3. The commentary 3 may be stored in the memory 12 or on a data carrier, it may be transmitted to the rendering component 6 and it may be rendered in a virtual or audible form by the rendering component 6, For example, the commentary may be displayed on a web page or simple GUI, fed into a Text-To-Speech engine and streamed as voice to the user, delivered as an MP3 file and played to the user or it could be streamed across a screen as text.

It may in some embodiments be desirable to encode the commentary 3 with a value representing the user profile at the time of manufacture. The rendering device may then check the user profile at the time of manufacture against the current user profile when the commentary is to be rendered. If there is a mismatch then the user may be given an option to delay rendering may until the commentary is re-manufactured based on the current user profile.

In one implementation, the rendering component 6 is used by a user to send a play-list to the control component 10 which generates a series of linking commentaries that go between each pair of music tracks. The control component may either send the linking commentaries to the rendering component for insertion between the playing of tracks on the rendering component or the control component can create a single MP3 file including the music tracks and commentaries as a pod cast

The blocks illustrated in the FIG. 3 may represent steps in a method and/or sections of code in the computer program 18. The illustration of a particular order to the blocks does not necessarily imply that there is a required or preferred order for the blocks and the order and arrangement of the block may be varied.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An automated disc jockey comprising:
means for accessing a database that models multiple music tracks as linked data objects each music track model comprising a music track data object, at least identifying the music track, linked to a plurality of other data objects that parameterize metadata of the music track, wherein at least some of the other data objects are sharable data objects that may be linked from any music track data object;
means for extracting, from the accessed database, data objects and links defining a model of a first music track;
means for extracting, from the accessed database, data objects and links that define a model of a second music track that is adjacent to and follows the first music track in a play-list
means for selecting a sub-set of the extracted data objects and links including interconnecting data objects and links that interconnect a first music track data object for the first music track and a second music track data object for the second music track via a shared data object that is shared between the model for the first music track and the model for the second music track; and
means for processing the interconnecting data objects and links to manufacture disc jockey commentary that joins the first music track and the second music track.

2. The automated disc jockey as claimed in claim 1, comprising a memory for storing a user profile, wherein the means for selecting is operable to use the stored user profile when selecting the sub-set.

3. The automated disc jockey as claimed in claim 1, wherein each extracted data object defining the model of the second music track has a path of N link(s) and N object(s) originating at the second music track data object and terminating at the extracted data object and wherein the selection of an extracted candidate data object for inclusion in the sub-set of extracted data objects is dependent upon the value of N for the extracted data object.

4. The automated disc jockey as claimed in claim 1, wherein each extracted candidate data object has a path of N link(s) and N object(s) originating at the second music track data object and terminating at the candidate data object, wherein link(s) and/or object(s) in a path has an associated value, and wherein the selection of the sub-set involves determining cumulative values of the values in the path for each extracted object and selecting one or more extracted objects for inclusion in the sub-set using the cumulative values.

5. The automated disc jockey as claimed in claim 4, wherein the associated values are dependent upon a user profile.

6. The automated disc jockey as claimed in claim 4, wherein the processing of interconnecting data objects and links, includes processing a shared data object having an optimum cumulative value to manufacture the disc jockey commentary.

7. The automated disc jockey as claimed in claim 1, wherein the means for processing the interconnecting data objects and links to manufacture disc jockey commentary that joins the first music track and the second music track, is configured to process interconnecting link(s) and data objects, if any, between the first music track data object and the shared data object to produce a first portion of the commentary, to process interconnecting link(s) and data objects, if any, between the second music track data object and the shared data object to produce a second portion of the commentary, and to process the shared data object to produce a linking portion that links the first and second portions.

8. The automated disc jockey as claimed in claim 1, wherein the play-list is predetermined.

9. The automated disc jockey as claimed in claim 1, configured to generate the play-list.

10. An automated disc jockey as claimed in claim 1, configured to render the disc jockey commentary.

11. The automated disc jockey as claimed in claim 1, configured to transmit the disc jockey commentary.

12. A computer-based method for manufacturing disc jockey commentary joining music tracks comprising:
accessing a database that models multiple music tracks as linked data objects each music track model comprising a music track data object, identifying the music track, linked to a plurality of other data objects that parameterize metadata of the music track, wherein at least some of the other data objects are sharable data objects that may be linked from any music track data object;
extracting, from the accessed database, data objects and links defining a first model of a first music track;
extracting, from the accessed database, data objects and links that define a second model of a second music track that is adjacent to and follows the first music track in a play-list;
selecting a sub-set of the extracted data objects and links including interconnecting data objects and links that interconnect a first music track data object for the first music track and a second music track data object for the second music track via a shared data object that is shared between the first model for the first music track and the second model for the second music track; and
computer processing the interconnecting data objects and links to manufacture a disc jockey commentary that joins the first music track and the second music track.

13. An automated method of simulating a radio station comprising:
accessing a database that models multiple music tracks as linked data objects each music track model comprising a music track data object, identifying the music track, linked to a plurality of other data objects that parameterize metadata of the music track, wherein at least some of the other data objects are sharable data objects that may be linked from any music track data object;
extracting, from the accessed database, data objects and links defining a first model of a first music track;
extracting, from the accessed database, data objects and links that define a second model of a second music track that is adjacent to and follows the first music track in a play-list;
selecting a sub-set of the extracted data objects and links including interconnecting data objects and links that interconnect a first music track data object for the first music track and a second music track data object for the second music track via a shared data object that is shared between the first model for the first music track and the second model for the second music track;
computer processing the interconnecting data objects and links to manufacture a disc jockey commentary that joins the first music track and the second music track;
playing the first music track;
playing the disc jockey commentary; and
then playing the second music track.
